(19) United States
(12) Patent Application Publication
(10) Pub. No.: US 2022/0004178 A1
(43) Pub. Date: Jan. 6, 2022

(54) ABNORMALITY DETECTION SYSTEM

(71) Applicant: TOYOTA JIDOSHA KABUSHIKI KAISHA, Toyota-shi (JP)

(72) Inventors: Shingo MATSUDA, Toyota-shi (JP); Satoshi Nishio, Toyota-shi (JP); Tetsuya Furuya, Toyota-shi (JP)

(73) Assignee: TOYOTA JIDOSHA KABUSHIKI KAISHA, Toyota-shi (JP)

(21) Appl. No.: 17/363,517

(22) Filed: Jun. 30, 2021

(30) Foreign Application Priority Data
Jul. 6, 2020 (JP) 2020-116173

(51) Int. Cl. G05B 23/02

(52) U.S. Cl. CPC G05B 23/0262

(57) ABSTRACT

An abnormality detection system configured to detect abnormal communication includes a first electronic control unit, a plurality of second electronic control units, a plurality of connector connection portions, and a processor. The connector connection portions are provided on a communication path between the first electronic control unit and the second electronic control units. Each connector connection portion includes a first connector portion and a second connector portion. The processor is configured to determine that, when abnormal communication occurs, one of the connector connection portions that is experiencing abnormal communication with all the second electronic control units connected to the second connector portion and that includes the second connector portion connected to the largest number of second electronic control units is abnormal.

### CROSS-REFERENCE TO RELATED APPLICATION

This application claims priority to Japanese Patent Application No. 2020-116173 filed on Jul. 6, 2020, incorporated herein by reference in its entirety.

### BACKGROUND

### 1. Technical Field

The present disclosure relates to abnormality detection systems, and more particularly to an abnormality detection system that detects abnormal communication.

### 2. Description of Related Art

A method for detecting a failure in a communication network in which a plurality of electronic control units (ECUs) are connected to a communication bus is known in the art (see, e.g., Japanese Unexamined Patent Application Publication No. 2009-302783 (JP 2009-302783 A). According to this method, after a communication error is detected, a transmission stop request is made to cause the ECUs to stop data transmission to the communication bus one by one. Every time one of the ECUs is caused to stop data transmission to the communication bus, it is determined whether there is any communication error on the communication bus. The location of the failure is thus identified.

### SUMMARY

However, the above method has the following problem. In the case where an abnormal signal is detected due to an abnormality on a communication path to which the ECUs are connected (e.g., in the case where a connector on the communication path is incompletely mated), an abnormal signal is detected regardless of which of the ECUs is stopped. Accordingly, the location of the abnormality cannot be identified.

The present disclosure provides an abnormality detection system capable of accurately identifying the location of abnormal communication.

The abnormality detection system according to a first aspect of the present disclosure is a system configured to detect abnormal communication and includes a first electronic control unit, a plurality of second electronic control units configured to communicate with the first electronic control unit, a plurality of connector connection portions, and a processor. The connector connection portions are provided on a communication path between the first electronic control unit and the second electronic control units. Each connector connection portion includes a first connector portion and a second connector portion. The first connector portion is provided on the communication path at a position closer to the first electronic control unit than the second connector portion, and the second connector portion is provided on the communication path at a position closer to the second electronic control units than the first connector portion. The processor is configured to determine that, when abnormal communication occurs, one of the connector connection portions that is experiencing abnormal communication with all the second electronic control units connected to the second connector portion and that includes the second connector portion connected to the largest number of second electronic control units is abnormal.

According to the abnormality detection system of the first aspect of the present disclosure, when abnormal communication occurs, the processor determines that the connector connection portion connected to the largest number of second electronic control units out of the connector connection portions that are experiencing abnormal communication with all the second electronic control units connected to the opposite side of the connector connection portions from the first electronic control unit is abnormal. Which of the connector connection portions on the communication path is abnormal can thus be accurately identified. As a result, the location of the abnormal communication can be accurately identified.

In the abnormality detection system of the first aspect of the present disclosure, the processor may be configured to determine that communication of the first electronic control unit is normal. According to the abnormality detection system of the first aspect of the present disclosure, whether the communication of the first electronic control unit is normal can be appropriately determined.

In the abnormality detection system according to the first aspect of the present disclosure, the first electronic control unit may be configured to diagnose whether the communication of the first electronic control unit is normal or abnormal. The processor may be configured to determine that the communication of the first electronic control unit is normal when the first electronic control unit diagnoses that the communication of the first electronic control unit is normal.

According to the abnormality detection system of the first aspect of the present disclosure, whether the communication of the first electronic control unit is normal can be appropriately determined based on the self-diagnosis result of the first electronic control unit.

In the abnormality detection system of the first aspect of the present disclosure, the processor may be configured to determine that the communication of the first electronic control unit is abnormal regardless of a determination result of whether any of the connector connection portions is abnormal, when the processor determines that the communication of the first electronic control unit is not normal.

According to the abnormality detection system of the first aspect of the present disclosure, when the processor does not determine that the communication of the first electronic control unit is normal, it is highly likely that the communication of the first electronic control unit is abnormal. An abnormality of the first electronic control unit can therefore be preferentially determined.

In the abnormality detection system of the first aspect of the present disclosure, the processor may be configured not to determine whether any of the connector connection portions is abnormal when the processor determines that the communication of the first electronic control unit is abnormal.

According to the abnormality detection system of the first aspect of the present disclosure, it may be no use determining whether any of the connector connection portions is abnormal when the communication of the first electronic control unit is abnormal. However, since the processor does not determine whether any of the connector connection portions is abnormal, the unnecessary determination process can be omitted.

In the abnormality detection system of the first aspect of the present disclosure, the first electronic control unit may be configured to determine that communication is abnormal when a communication outage with any of the second electronic control units lasts for a predetermined period or more.

According to the abnormality detection system of the first aspect of the present disclosure, which of the connector connection portions on the communication path is abnormal can be clearly determined.

According to the abnormality detection system of the first aspect of the disclosure, an abnormality detection system can be provided which can accurately identify the location of abnormal communication.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates a general configuration of a vehicle according to an embodiment;

FIG. 2 illustrates an example of a network configuration in the vehicle according to the embodiment; and

FIG. 3 is a flowchart of an abnormal communication detection process according to the embodiment.

### DETAILED DESCRIPTION OF EMBODIMENTS

An embodiment of the present disclosure will be described with reference to the accompanying drawings. In the following description, the same components are denoted with the same signs. These components have the same names and functions. Accordingly, detailed description of these components will not be repeated.

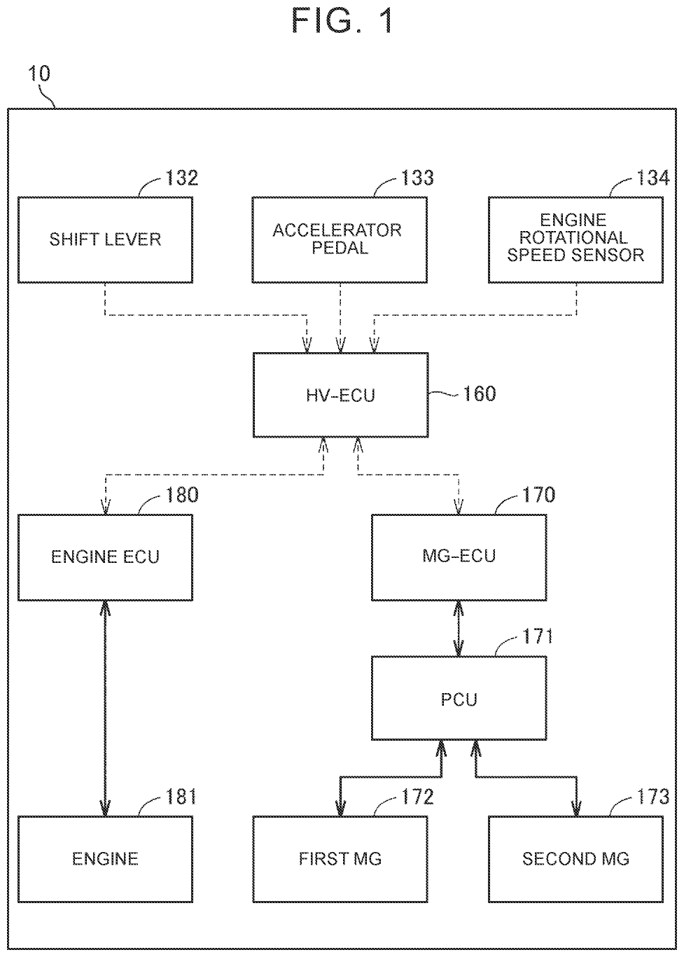

FIG. 1 illustrates a general configuration of a vehicle 10 according to the embodiment. Referring to FIG. 1, the vehicle 10 is a hybrid vehicle. The vehicle 10 has, as a general configuration, a shift lever 132, an accelerator pedal 133, a hybrid vehicle electronic control unit (HV-ECU) 160, a motor generator ECU (MG-ECU) 170, a power control unit (PCU) 171, a first motor generator (MG) 172, a second MG 173, an engine ECU 180, an engine 181, and an engine rotational speed sensor 134.

The shift lever 132 is a lever for switching among a plurality of shift ranges according to a shift operation performed by a user, and includes a sensor for detecting the position to which the shift lever 132 has been shifted. The shift ranges that can be selected by the shift lever 132 include, e.g., a neutral (N) range, a reverse (R) range, a drive (D) range, and a brake (B) range. The shift lever 132 sends a signal indicating the shift range corresponding to the position detected by the sensor to the HV-ECU 160.

The accelerator pedal 133 is a pedal for receiving an accelerator operation performed by the user, and includes a sensor for detecting the amount of depression of the accelerator pedal 133. The accelerator pedal 133 sends a signal indicating the amount of depression detected by the sensor to the HV-ECU 160.

The HV-ECU 160 is an ECU for controlling traction of the vehicle 10 and can communicate with the MG-ECU 170 and the engine ECU 180 via an in-vehicle communication network (e.g., a controller area network (CAN)).

Each of the following ECUs includes a central processing unit (CPU) and a memory. The memory can store programs and data. The CPU processes the data stored in the memory and data received from other parts and stores the processing results in the memory or sends the processing results to the other parts, according to the programs stored in the memory.

The HV-ECU 160 outputs control signals for controlling the first MG 172 and the second MG 173 to the MG-ECU 170 and outputs a control signal for controlling the engine 181 to the engine ECU 180 in response to the signals from the shift lever 132 and the accelerator pedal 133.

The MG-ECU 170 is an ECU for controlling the first MG 172 and the second MG 173 of the vehicle 10 and sends control signals for controlling the first MG 172 and the second MG 173 to the PCU 171 in response to the control signals from the HV-ECU 160 and a signal from the PCU 171.

The PCU 171 includes two inverters, one for the first MG 172 and one for the second MG 173, and a converter for converting a voltage. The PCU 171 carries out bidirectional power conversion between a battery and the first MG 172 and the second MG 173 in response to the control signals from the MG-ECU 170. Specifically, the PCU 171 supplies electric power of the battery as electric power for driving the first MG 172 and the second MG 173 or supplies electric power regenerated by the first MG 172 and the second MG 173 to charge the battery.

The first MG 172 and the second MG 173 are alternating current (AC) rotating electrical machines, for example, three-phase AC synchronous motors having permanent magnets embedded in a rotor. The first MG 172 and the second MG 173 generate a driving force by the electric power from the PCU 171 or supply regenerative electric power to the PCU 171.

The engine ECU 180 is an ECU for controlling the engine 181 of the vehicle 10, and controls each part of the engine 181 in response to the control signal from the HV-ECU 160 and signals from each sensor for the engine 181. The engine 181 is, e.g., a gasoline engine or a diesel engine, and burns fuel to generate a driving force in response to a control signal from the engine ECU 180. The engine rotational speed sensor 134 detects the rotational speed of the engine 181 and sends a signal indicating the detected rotational speed to the HV-ECU 160.

In the vehicle 10 of the embodiment, the first MG 172, the second MG 173, and the engine 181 are connected so that the first MG 172, the second MG 173, and the engine 181 can transmit power to each other by a planetary gear mechanism. A shaft to which the second MG 173 is connected is connected to drive wheels of the vehicle 10. The first MG 172 generates electricity mainly by the driving force from the engine 181. The second MG 173 drives the drive wheels or regenerates kinetic energy from the drive wheels. The engine 181 drives the first MG 172 or drives the drive wheels.

There is a method for detecting a failure in a communication network in which a plurality of ECUs are connected to a communication bus. According to this method, after a communication error is detected, a transmission stop request is made to cause the ECUs to stop data transmission to the communication bus one by one. Every time one of the ECUs is caused to stop data transmission to the communication bus, it is determined whether there is any communication error on the communication bus. The location of the failure is thus identified.

However, the above method has the following problem. In the case where an abnormal signal is detected due to an abnormality on a communication path to which the ECUs are connected (e.g., in the case where a connector on the communication path is incompletely mated), an abnormal signal is detected regardless of which of the ECUs is stopped. Accordingly, the location of the abnormality cannot be identified.

In the abnormality detection system according to the present disclosure, in the case where each connector connection portion on a communication path has a first connector portion located on the first ECU (e.g., HV-ECU 160) side on the communication path and a second connector portion located on the second ECU side on the communication path, the first ECU being different from the second ECUs, the abnormality detection system includes a diagnosis unit that determines, when abnormal communication occurs, the connector connection portion connected to the largest number of second ECUs out of the connector connection portions that are experiencing abnormal communication with all the second ECUs connected to their second connector portions is abnormal. The location of the abnormal communication can thus be accurately identified.

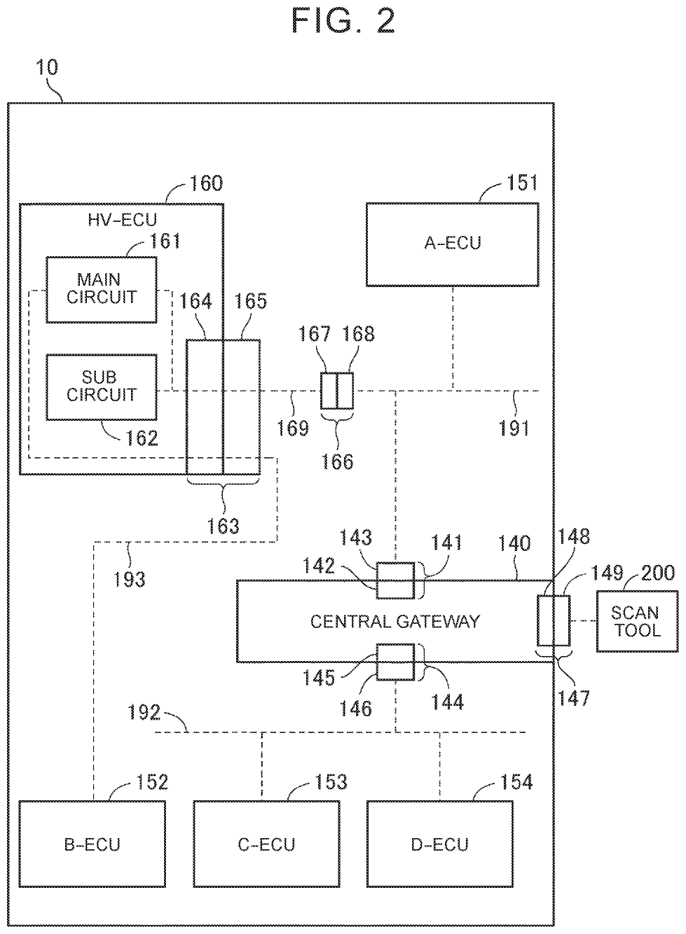

Features of the embodiment will be described. FIG. 2 illustrates an example of a network configuration in the vehicle 10 according to the embodiment. Referring to FIG. 2, the vehicle 10 includes an A-ECU 151, a B-ECU 152, a C-ECU 153, a D-ECU 154, and a central gateway 140 as ECUs for controlling other functions, in addition to the HV-ECU 160.

The central gateway 140 is an ECU as a gateway for connecting a plurality of CAN buses to each other. The A-ECU 151 to the D-ECU 154 are ECUs for controlling specific functions of the vehicle 10 such as the MG-ECU 170 and the engine ECU 180.

Each ECU is connected as a node to a communication line such as a CAN bus. For example, the HV-ECU 160, the central gateway 140, and the A-ECU 151 are connected as nodes to a CAN bus 191. The central gateway 140, the C-ECU 153, and the D-ECU 154 are connected as nodes to a CAN bus 192. The HV-ECU 160 and the B-ECU 152 are connected by a dedicated communication line 193.

The central gateway 140 is connected to the bus 191 by a connector 141. The connector 141 is a combination of a female connector (socket, jack, receptacle) 142 on the central gateway 140 side and a male connector (plug) 143 on the bus 191 side. The connector 141 is a wire-to-board connector for connecting the bus 191 to the central gateway 140.

The central gateway 140 is connected to the bus 192 by a connector 144. The connector 144 is a combination of a female connector (socket, jack, receptacle) 145 on the central gateway 140 side and a male connector (plug) 146 on the bus 192 side. The connector 144 is a wire-to-board connector for connecting the bus 192 to the central gateway 140.

The HV-ECU 160 is connected to the bus 191 by a connector 166 connected to a connector 163 by a CAN cable 169. The connector 166 is a combination of a female connector 167 on the HV-ECU 160 side and a male connector 168 on the bus 191 side. The connector 166 is a wire-to-wire connector for connecting the bus 191 and the CAN cable 169.

The HV-ECU 160 is also connected to the B-ECU 152 by the dedicated communication line 193 connected to the connector 163. The connector 163 is a combination of a female connector 164 on the HV-ECU 160 side and a male connector 165 on the CAN cable 169 side and the dedicated communication line 193 side. The connector 163 is a wire-to-board connector for connecting the CAN cable 169 and the dedicated communication line 193 to the HV-ECU 160.

A scan tool 200 is a device connected to the vehicle 10 to diagnose a failure etc. in the ECUs and the central gateway 140 of the vehicle 10 and display the diagnosis results on a display. In the vehicle 10 of the embodiment, the scan tool 200 is connected to the central gateway 140 by a connector 147. However, the scan tool 200 need not necessarily be connected to the central gateway 140 by the connector 147, and the vehicle 10 may be provided with a dedicated connector for connecting the scan tool 200. The connector 147 is a combination of a female connector 148 on the central gateway 140 side and a male connector 149 on the scan tool 200 side. The connector 147 is a wire-to-board connector for connecting the scan tool 200 to the central gateway 140. The scan tool 200 includes a CPU (processor) for executing various processes and a memory that stores programs to be executed by the CPU or that is used as a work memory for executing the programs.

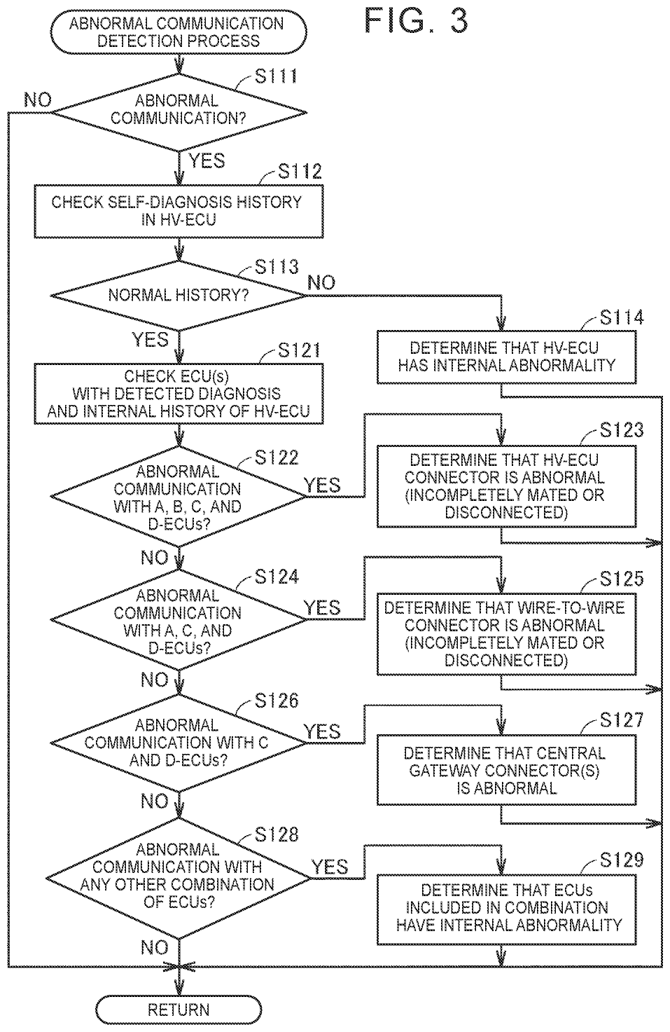

FIG. 3 is a flowchart of an abnormal communication detection process according to the embodiment. The abnormal communication detection process is called from a higher-level process and executed by the CPU of the scan tool 200 after the scan tool 200 is connected to the central gateway 140 of the vehicle 10.

Referring to FIG. 3, the CPU of the scan tool 200 communicates with each ECU of the vehicle 10 to determine whether there is any history of abnormal communication stored in the memory of each ECU (step S111). When the CPU of the scan tool 200 determines that there is no history of abnormal communication stored (NO in step S111), the CPU of the scan tool 200 returns the process to be executed to the higher-level process from which the abnormal communication detection process was called.

On the other hand, when the CPU of the scan tool 200 determines that there is a history of abnormal communication stored (YES in step S111), the CPU of the scan tool 200 checks a self-diagnosis history stored in the memory of the HV-ECU 160 (step S112).

In the embodiment, the HV-ECU 160 has a self-diagnosis function. Other ECU(s) may have a self-diagnosis function. The self-diagnosis function is a function to store, as a self-diagnosis history, information on any abnormality that has occurred in the configuration of the vehicle 10 such as various sensors and actuators of the vehicle 10 and configurations for communication in the vehicle 10 like communication between the ECUs and to notify the driver that an abnormality has occurred by turning on a warning lamp indicating the abnormality. In the embodiment, not only a history of abnormality such as abnormal communication with any of the ECUs but also a normal history are stored as the self-diagnosis history.

Next, the CPU of the scan tool 200 determines whether the self-diagnosis history checked in step S112 includes any history indicating that communication was normal (step S113). When the CPU of the scan tool 200 determines that the self-diagnosis history includes no normal history (NO in step S113), the CPU of the scan tool 200 determines that the HV-ECU 160 has an internal abnormality (step S114). The CPU of the scan tool 200 then returns the process to be executed to the higher-level process from which the abnormal communication detection process was called.

On the other hand, when the CPU of the scan tool 200 determines that the self-diagnosis history includes a normal history (YES in step S113), the CPU of the scan tool 200 checks the ECU(s) detected as experiencing abnormal communication with the HV-ECU 160 according to the self-diagnosis result (herein referred to as “diagnosis”) of the self-diagnosis function and the ECU(s) having experienced abnormal communication with the HV-ECU 160 according to an internal history of the self-diagnosis results of the HV-ECU 160 (step S121).

For example, in the case where a communication outage with any of the ECUs lasts for a predetermined period or more, the ECU having the self-diagnosis function such as the HV-ECU 160 detects the communication outage by the self-diagnosis function and stores information on the communication outage in the memory as the internal history of the self-diagnosis result.

As a result of checking the ECUs in step S121, the CPU of the scan tool 200 determines whether there has been abnormal communication between the HV-ECU 160 and the A-ECU 151 to the D-ECU 154 (step S122). When the CPU of the scan tool 200 determines that there has been abnormal communication between the HV-ECU 160 and the A-ECU 151 to the D-ECU 154 (YES in step S122), the CPU of the scan tool 200 determines that the connector 163 of the HV-ECU 160 is abnormal (incompletely mated or disconnected) (step S123). The CPU of the scan tool 200 then returns the process to be executed to the higher-level process from which the abnormal communication detection process was called.

When the CPU of the scan tool 200 determines that there has been no abnormal communication between the HV-ECU 160 and the A-ECU 151 to the D-ECU 154 (NO in step S122), the CPU of the scan tool 200 determines whether there has been abnormal communication between the HV-ECU 160 and the A-ECU 151, the C-ECU 153, and the D-ECU 154 as a result of checking the ECUs in step S121 (step S124). When the CPU of the scan tool 200 determines that there has been abnormal communication between the HV-ECU 160 and the A-ECU 151, the C-ECU 153, and the D-ECU 154 (YES in step S124), the CPU of the scan tool 200 determines that the connector 166, which is a wire-to-wire connector, is abnormal (incompletely mated or disconnected) (step S125). The CPU of the scan tool 200 then returns the process to be executed to the higher-level process from which the abnormal communication detection process was called.

When the CPU of the scan tool 200 determines that there has been no abnormal communication between the HV-ECU 160 and the A-ECU 151, the C-ECU 153, and the D-ECU 154 (NO in step S124), the CPU of the scan tool 200 determines whether there has been abnormal communication between the HV-ECU 160 and the C-ECU 153 and the D-ECU 154 as a result of checking the ECUs in step S121 (step S126). When the CPU of the scan tool 200 determines that there has been abnormal communication between the HV-ECU 160 and the C-ECU 153 and the D-ECU 154 (YES in step S126), the CPU of the scan tool 200 determines that either or both of the connector 141 and the connector 144 of the central gateway 140 are abnormal (incompletely mated or disconnected) (step S127). The CPU of the scan tool 200 then returns the process to be executed to the higher-level process from which the abnormal communication detection process was called.

When the CPU of the scan tool 200 determines that there has been no abnormal communication between the HV-ECU 160 and the C-ECU 153 and the D-ECU 154 (NO in step S126), the CPU of the scan tool 200 determines whether there has been abnormal communication between the HV-ECU 160 and any other combination of the ECUs as a result of checking the ECUs in step S121 (step S128). When the CPU of the scan tool 200 determines that there has been abnormal communication between the HV-ECU 160 and any other combination of the ECUs (YES in step S128), the CPU of the scan tool 200 determines that the ECUs included in the combination have an internal abnormality (step S129). The CPU of the scan tool 200 then returns the process to be executed to the higher-level process from which the abnormal communication detection process was called.

When the CPU of the scan tool 200 determines that there has been no abnormal communication between the HV-ECU 160 and any other combination of the ECUs (NO in step S128), the CPU of the scan tool 200 returns the process to be executed to the higher-level process from which the abnormal communication detection process was called.

In the higher-level process, the scan tool 200 may display the abnormality detected in the abnormal communication detection process, may store the detected abnormality in the internal memory, or may send the detected abnormality to an external computer.

In CAN communication, when a communication outage lasts long enough, both the HV-ECU 160 and other ECU(s) confirm the self-diagnosis result of the communication outage. However, the ECUs other than the HV-ECU 160 often confirm the self-diagnosis result faster than the HV-ECU 160.

This is because the time it takes to confirm the self-diagnosis result of the abnormal communication is determined by the transmission cycle of communication data. The HV-ECU 160 transmits information (e.g., vehicle speed, accelerator operation amount, shift position information) to be used by the ECUs other than the HV-ECU 160 for control in a shorter cycle. On the other hand, the reception cycle of the HV-ECU 160 is longer than the transmission cycle thereof. The time it takes for the ECUs other than the HV-ECU 160 to confirm the self-diagnosis result of the communication outage with the HV-ECU 160 is therefore shorter than the time it takes for the HV-ECU 160 to confirm the self-diagnosis result of the communication outage with any of the ECUs other than the HV-ECU 160.

Accordingly, in the case where communication quickly recovers from the outage, the ECUs other than the HV-ECU 160 store the self-diagnosis result of the communication outage as a history, while the HV-ECU 160 does not store the self-diagnosis result of the communication outage as a history. As a result, even when the communication outage is due to a factor other than the HV-ECU 160, the HV-ECU 160 is erroneously determined to be abnormal based on the history of the self-diagnosis result, and the HV-ECU 160 that is not abnormal will be replaced with a normal one.

It is possible to narrow down the location of the abnormality by the combination of ECUs that detect the self-diagnosis result of the communication outage. However, the combination of ECUs having detected the self-diagnosis result cannot distinguish between a connector abnormality such as incomplete mating of the connector 163 of the HV-ECU 160 and an internal abnormality of the ECU (e.g., microcomputer abnormality). This is because there is no information for segmenting between abnormalities inside and outside of the HV-ECU 160. Accordingly, even in the case of a connector abnormality, the HV-ECU 160 is erroneously determined to be abnormal, and the HV-ECU 160 that is not abnormal will be replaced with a normal one.

According to the present disclosure, as described above, each ECU having the self-diagnosis function stores, as an internal history, information on any one of the ECUs with which the ECU has experienced a communication outage. The HV-ECU 160 stores a history of normal communication. Accordingly, whether the detected abnormality is an abnormality inside of the HV-ECU 160 or outside of the HV-ECU 160 can be identified, and in the case of an abnormality outside of the HEV-ECU 160, the location of the abnormality between the HV-ECU 160 and other ECU(s) can be identified.

As a result, the HV-ECU 160 that is normal will not be replaced. A mechanic of the vehicle 10 can correctly repair the abnormal part by checking the abnormality detection result.

Modifications

(1) In the above embodiment, the vehicle 10 is a hybrid vehicle. However, the vehicle 10 need not necessarily be a hybrid vehicle and may be any vehicle. For example, the vehicle 10 may be a vehicle equipped with an engine but no MG, may be an electric vehicle equipped with an MG but no engine, or may be a fuel cell vehicle including an MG and fuel cells.

(2) In the connectors of the above embodiment, the female connector and the male connector may be opposite to those in the configuration described above.

(3) In the above embodiment, the abnormal communication detection process of FIG. 3 is executed by the scan tool 200. However, the abnormal communication detection process need not necessarily be executed by the scan tool 200 and may be executed by any of the ECUs of the vehicle 10, for example, by the HV-ECU 160.

(4) The above embodiment can be regarded as disclosing the abnormality detection system including the vehicle 10 and the scan tool 200, can be regarded as disclosing the vehicle 10, can be regarded as disclosing the scan tool 200, or can be regarded as disclosing the abnormality detection method that is performed by the abnormality detection system, the vehicle 10, or the scan tool 200.

### CONCLUSION

(1) As shown in FIGS. 1 to 3, the abnormality detection system according to the present disclosure is a system for detecting abnormal communication. As shown in FIGS. 1 and 2, the abnormality detection system includes the first ECU (e.g., HV-ECU 160), the second ECUs (e.g., A-ECU 151 to D-ECU 154) capable of communicating with the first ECU, and the connector connection portions (e.g., connectors 141, 144, 163, 166) on the communication path between the first ECU and the second ECUs.

As shown in FIG. 2, each of the connector connection portions has the first connector portion (e.g., female connector 164, 167, 145, male connector 143) on the first ECU side on the communication path and the second connector portion (e.g., male connector 165, 168, 146, female connector 142) on the second ECU side on the communication path. As shown in FIG. 3, the abnormality detection system further includes the diagnosis unit (which may be, e.g., the scan tool 200 or the ECU of the vehicle 10 such as the HV-ECU 160; e.g., steps S122 to S127) that determines, when abnormal communication occurs, the connector connection portion connected to the largest number of second ECUs out of the connector connection portions that are experiencing abnormal communication with all the second ECUs connected to the second connector portions is abnormal.

Accordingly, when abnormal communication occurs, it is determined that the connector connection portion connected to the largest number of second ECUs out of the connector connection portions that are experiencing abnormal communication with all the second ECUs connected to the opposite side of the connector connection portions from the first ECU is abnormal. Which of the connector connection portions on the communication path is abnormal can thus be accurately identified. As a result, the location of the abnormal communication can be accurately identified.

(2) As shown in FIG. 3, the diagnosis unit may determine that communication of the first ECU is normal (e.g., step S113). Whether the communication of the first ECU is normal can thus be appropriately determined.

(3) As shown in FIG. 3, the first ECU may diagnose whether communication of the first ECU is normal or abnormal (e.g., the HV-ECU 160 has the self-diagnosis function), and the diagnosis unit may determine that the communication of the first ECU is normal when the first ECU determines that the communication of the first ECU is normal (e.g., step S113).

Whether the communication of the first ECU is normal can thus be appropriately determined based on the self-diagnosis result of the first ECU.

(4) As shown in FIG. 3, when it is determined that communication of the first ECU is not normal (e.g., NO in step S113), the diagnosis unit may determine that the communication of the first ECU is abnormal (e.g., step S114) regardless of the determination result of whether any of the connector connection portions is abnormal (e.g., regardless of the results of steps S121 to S127).

In this case, when it is not determined that communication of the first ECU is normal, it is highly likely that communication of the first ECU is abnormal. An abnormality of the first ECU can therefore be preferentially determined.

(5) As shown in FIG. 3, when it is determined that communication of the first ECU is abnormal (e.g., NO in step S113), the diagnostic unit may not determine whether any of the connector connection portions is abnormal (e.g., steps S121 to S127 may not be performed).

It may be no use determining whether any of the connector connection portions is abnormal when communication of the first ECU is abnormal. However, since the diagnosis unit does not determine whether any of the connector connection portions is abnormal, the unnecessary determination process can be omitted.

(6) As described with respect to step S121 of FIG. 3, when a communication outage with any of the second ECUs lasts for a predetermined period or more, the first ECU may determine that the communication is abnormal. Which of the connector connection portions on the communication path is abnormal can thus be clearly determined.

The embodiment disclosed herein should be considered as illustrative and not restrictive in all respects. The scope of the present disclosure is defined by the claims, rather than the above description, and is intended to include all modifications within the meaning and scope equivalent to those of the claims.

What is claimed is:

1. An abnormality detection system configured to detect abnormal communication, comprising:
a first electronic control unit;
a plurality of second electronic control units configured to communicate with the first electronic control unit;
a plurality of connector connection portions provided on a communication path between the first electronic control unit and the second electronic control units and each including a first connector portion and a second connector portion, the first connector portion being provided on the communication path at a position closer to the first electronic control unit than the second connector portion, and the second connector portion being provided on the communication path at a position closer to the second electronic control units than the first connector portion; and
a processor configured to determine that, when abnormal communication occurs, one of the connector connection portions that is experiencing abnormal communication with all the second electronic control units connected to the second connector portion and that includes the second connector portion connected to the largest number of second electronic control units is abnormal.

2. The abnormality detection system according to claim 1, wherein the processor is configured to determine that communication of the first electronic control unit is normal.

3. The abnormality detection system according to claim 2, wherein:
the first electronic control unit is configured to diagnose whether the communication of the first electronic control unit is normal or abnormal; and
the processor is configured to determine that the communication of the first electronic control unit is normal when the first electronic control unit diagnoses that the communication of the first electronic control unit is normal.

4. The abnormality detection system according to claim 2, wherein the processor is configured to determine that the communication of the first electronic control unit is abnormal regardless of a determination result of whether any of the connector connection portions is abnormal, when the processor determines that the communication of the first electronic control unit is not normal.

5. The abnormality detection system according to claim 4, wherein the processor is configured not to determine whether any of the connector connection portions is abnormal when the processor determines that the communication of the first electronic control unit is abnormal.

6. The abnormality detection system according to claim 1, wherein the first electronic control unit is configured to determine that communication is abnormal when a communication outage with any of the second electronic control units lasts for a predetermined period or more.
